(19) United States
(12) Patent Application Publication
(10) Pub. No.: US 2026/0100615 A1
(43) Pub. Date: Apr. 9, 2026

(54) Thrust Producing Electric Motor with Static Shaft

(71) Applicant: Jesse Smith, Oldsmar, FL (US)

(72) Inventor: Jesse Smith, Oldsmar, FL (US)

(21) Appl. No.: 18/907,688

(22) Filed: Oct. 7, 2024

(51) Int. Cl. H02K 1/2789; H02K 7/08; H02K 7/14; H02K 11/215

(52) U.S. Cl. CPC H02K 1/2789; H02K 7/086; H02K 7/14; H02K 11/215

(57) ABSTRACT

Disclosed are improved constructions for electric motors. This disclosure relates to an electric motor that employs both permanent magnets and electromagnets and that operates about a static shaft. Also disclosed in the use of a segmented rotor. A further embodiment is disclosed showing a rotor and stator that are magnetically levitated within a chamber formed by upper and lower housings.

### TECHNICAL FIELD

This disclosure relates to improvements in electric motors. More particularly, the present disclosure relates to an electric motor with a static central shaft that can be used to produce thrust.

### BACKGROUND OF THE INVENTION

There are a wide variety of electric motor designs in the background art. For example, U.S. Pat. No. 3,859,549 to Boesel discloses a dynamoelectric machine including stator and armature structures. The stator includes a yoke and a plurality of pole shoes which include slots for receiving compensating coils. Strand-like elements are tightly packed within the slots between the compensating coils and the slot walls and are embedded within a hardened binder material, to support the coils against oscillation. Each pole shoe includes tip and base sections defining a pole face.

U.S. Pat. No. 4,276,490 to Saldinger discloses a brushless DC motor comprising a steel ring rotor on which rare-earth magnets are fastened and a segmented stator having a comb-like core for each segment. Due to their high coercivity, the rare-earth magnets can operate into air circuits between stator segments without demagnetization, returning to their high flux levels upon re-entering a stator segment.

U.S. Pat. Pub. 2008/0246362 to Hirzel discloses a radial gap, transverse flux dynamoelectric machine comprising a stator and rotor assemblies. The rotor assembly comprises at least two axially spaced, planar rotor layers having equal numbers of magnetic poles of alternating polarity disposed equiangularly about the rotor peripheral circumference. The stator assembly comprises a plurality of amorphous metal stator cores terminating in first and second pole faces. The cores are disposed equiangularly about the peripheral circumference of the stator assembly with their pole faces axially aligned. Respective first and second pole faces are in layers radially adjacent corresponding rotor layers. Stator windings encircle the stator cores.

Finally, U.S. Pat. Pub. 2022/0263388 to Shaw et. al. discloses planar stator configurations for axial flux machines. The stator structures may be disposed within a gap of an axial flux machine. In some embodiments, an axial flux machine may include a planar stator having a winding arranged to be positioned within the machine's active region and may further include at least one switch configured to be selectively closed to establish an electrical connection between respective ends of the winding at a time that the winding is not coupled to an external power source.

Although the foregoing background references all achieve their own unique objective, all suffer from common drawbacks. Namely, none of the background motors disclose use of a segmented stator, the use of permanent magnets with alternating polarity, or a static central saft. The electric motors of the present disclosure are aimed at overcoming these and other shortcomings found in the background art.

### SUMMARY OF THE INVENTION

This disclosure relates to a thrust producing electric motor.

The disclosed motors have several important advantages. For example, the thrust producing motors of the present disclosure can operative relative to a static central shaft. Namely, the electric motors described herein rotate about a central shaft that does not move or rotate. The use of a static shaft eliminates potential failure points and greatly reduces needed maintenance.

In yet another advantage of the present motors, is the ability to provide a segmented stator. Namely, in the present motor designs do not require a stator that completely surrounds the associated rotor. Thus, the use of a segmented rotor minimizes the number of components, reduces the weight of the motor, and provides greater access to the rotor.

A further advantage of the present motor designs is the use of alternating permanent magnets about the entire periphery of the rotor. This increases the electrical and mechanical efficiency of the motor, while at the same time reducing manufacturing and operational costs.

Yet another advantage is realized by including a rotor and stator that are magnetically levitated within a surrounding chamber to avoid friction and wear.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a top plan view of a first embodiment of the motor of the present disclosure.

FIG. 2 is a perspective view of the rotor of the first embodiment of the present disclosure.

FIG. 3 is a perspective view of the first embodiment showing the outer stator positioned about the inner rotor.

FIG. 4 is a partially exploded view of the first embodiment of the motor showing the upper and lower housings, stator, and rotor.

FIG. 5 is a top plan view of an alternative design of the motor and showing use of a segmented stator.

FIG. 6 is a perspective view of an alternative design of the motor and showing use of a segmented stator.

FIG. 7 is a perspective view of an alternative design of the motor and showing use of a segmented stator.

FIG. 8 is a plan view of the lower housing of a second embodiment of the present disclosure.

FIG. 9 is a perspective view of the rotor of the second embodiment of the present disclosure.

FIG. 10 is a partially exploded view of the stator, rotor, and lower housing of second embodiment of the present disclosure.

FIG. 11 is a partially exploded view of the stator, rotor, and upper and lower housings of second embodiment of the present disclosure.

FIG. 12 is a partially exploded view of the stator, rotor, upper and lower housings, and mounting plates of second embodiment of the present disclosure.

Similar reference numerals refer to similar parts throughout the several views of the drawings.

Parts List

20 Electric Motor
22 Static Shaft
24 Rotor
26 Central Bearing
28 Outer Peripheral Extent of Rotor
32 Permanent Magnets
34 Angled Blades
36 Stator
38 Inner Peripheral Extent of Stator
42 Electromagnets
44 Upper Housing
46 Mounting Points Upper Housing
48 Spokes of Upper Housing
52 Central Opening Upper Housing
54 Lower Housing
56 Mounting Point Lower Housing
58 Spokes of Lower Housing
62 Central Opening Lower Housing
64 Alternative Embodiment of Motor
66 Rotor of Alternative Embodiment
68 Blades of Alternative Embodiment
70 Permanent Magnets
72 Bearing of Alternative Embodiment
74 Segmented Stator
76 Stator Supports
78 Electromagnets
120 Motor
122 Rotor
124 Stator
126 Electromagnets
128 Permanent Magnets
132 Upper Housing
134 Lower Housing
136 Upwardly Facing Magnets- Housing
138 Downwardly Facing Magnets-Housing
142 Upwardly Facing Magnets -Stator
144 Downwardly Facing Magnets - Stator
146 Hall Effect Sensor
148 Mounting Plate
152 Mounting Point

### DETAILED DESCRIPTION OF THE DRAWINGS

The present disclosure relates to improved constructions for electric motors. In particular, this disclosure relates to an electric motor that employs both permanent magnets and electromagnets and that operates about a static shaft. Also disclosed in the use of a segmented rotor.

Electric Motor with Static Shaft

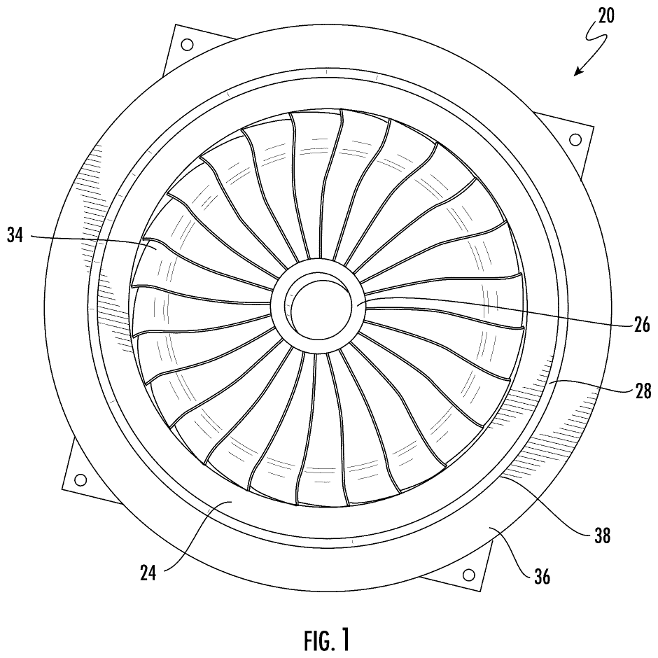

With reference now to FIG. 1, a thrust producing electric motor (20) is depicted. This motor includes a static central shaft (22) and a rotor (24). Rotor (24) includes a central bearing (26) and an outer peripheral extent (28). A series of permanent magnets (32) are secured within the peripheral extent (28) of the rotor (24), with immediately adjacent permanent magnets (32) having an opposite polarity. The static central shaft (22) is preferably positioned within the central bearing (26).

A series of angled blades (34) are positioned within the rotor (24). Namely, each angled blade (34) is attached to, and extending outwardly from, the central bearing (26) of the rotor (24). The series of angled blades (34) function to produce thrust upon rotation of the rotor (24) about the static central shaft (22). Although this embodiment illustrates the use of blades (34) to produce thrust, the rotational motion produced by motor (20) can be used in a variety of other ways. For example, rotor (24) can be used to drive an axle, rotate a gear, or as a power take off. It can also be used to generate electricity.

The motor (20) further includes a stator (36) that is positioned about the rotor (24) but not in physical contact with the rotor (24). Preferably an air gap exists between the stator (36) and rotor (24). Stator (36) has an inner peripheral extent (38), with the inner peripheral extent (38) housing a series of electromagnets (42). In a preferred embodiment, immediately adjacent electromagnets (42) are driven by a different phased current. As such, the electromagnets (42) of the stator (26) and the permanent magnets (32) of the rotor (24) interact to rotate the rotor (24) about the static central shaft (22).

The rotor (24) and stator (36) are positioned within an upper and lower housing. Namely, an upper housing (44) with mounting points (46) includes a series of spokes (48) and a central opening (52). The static central shaft (22) is positioned within the central opening (52) of the upper housing (44). A lower housing (54) is also included with mounting points (56). The lower housing (54) likewise includes a series of spokes (58) and a central opening (62). The static central shaft (22) is positioned within the central opening (62) of the lower housing (54), whereby the upper and lower housings (44, 54) function to enclose and protect the inner stator (36) and outer rotor (24).

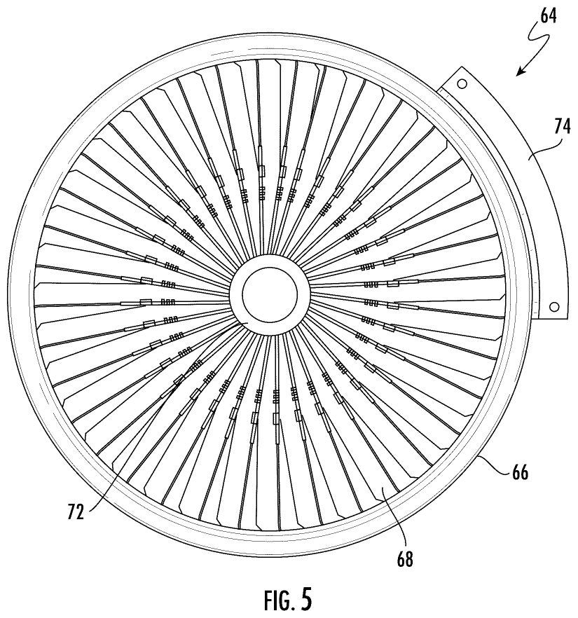

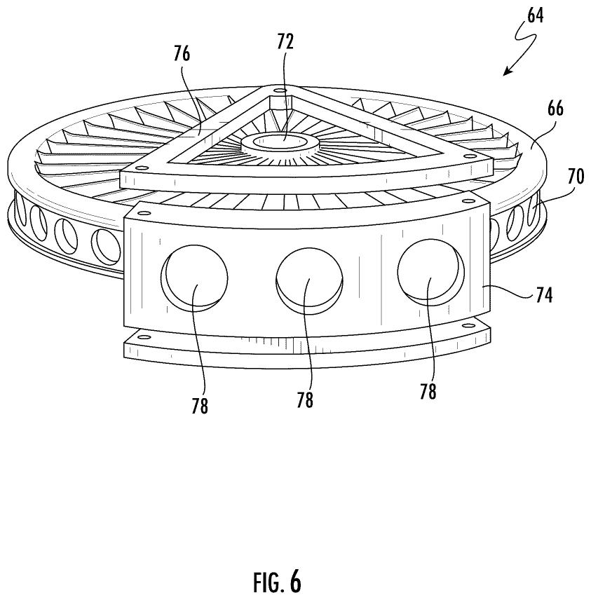

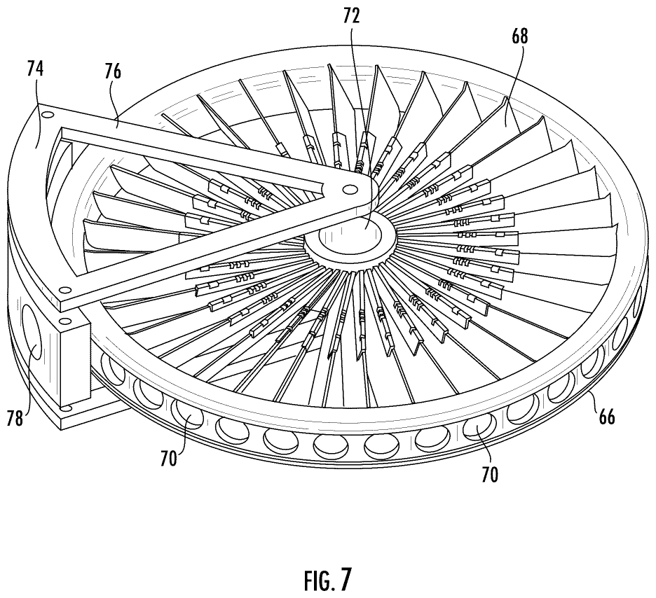

An alternative embodiment of motor (64) is illustrated in FIGS. 5-7. As with the primary embodiment, this embodiment includes a rotor (66) with blades (68) and a central bearing (72). However, this embodiment includes a segmented rotor (74) that only extends over a portion of the rotor (66). As with the primary embodiment, permanent magnets (70) are positioned along the outer periphery of the rotor (66) with electromagnets (78) extending along the length of the segmented stator (74). The segmented rotor (74) is supported on either side of the rotor (66) via supports (76).

### Levitating Electric Motor

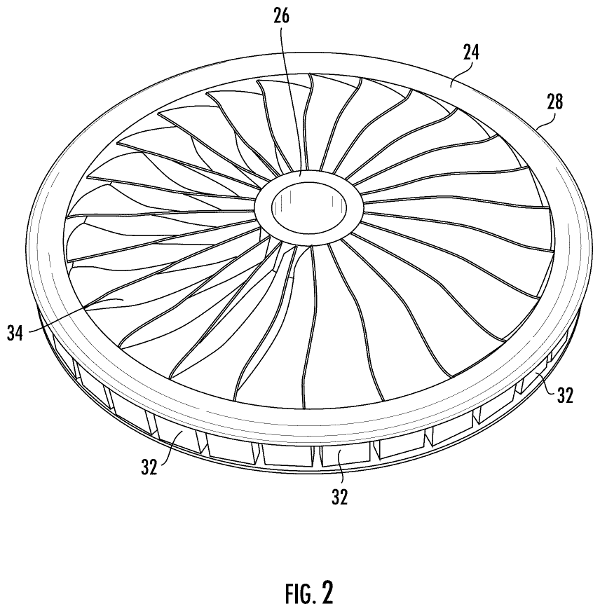

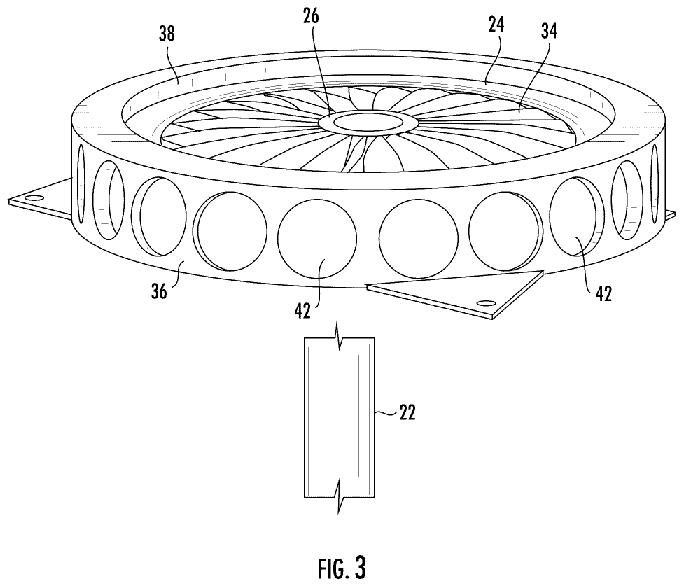

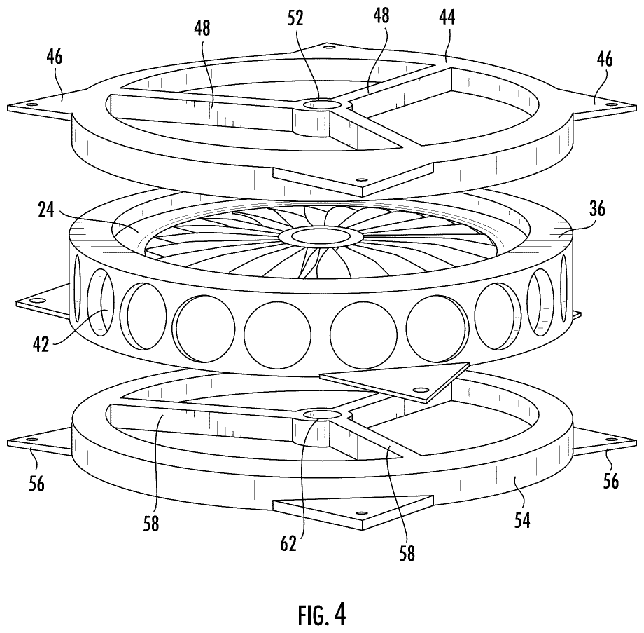

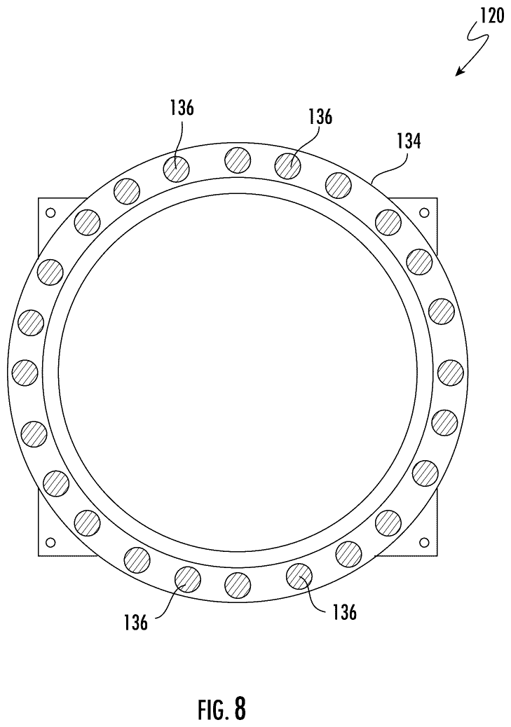

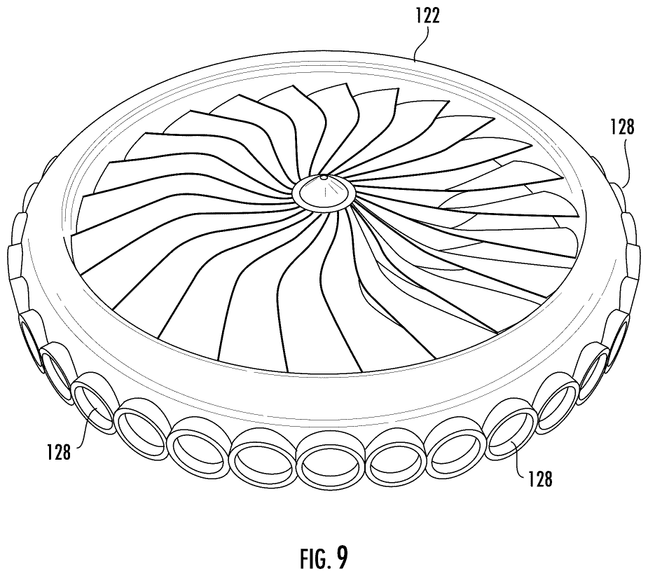

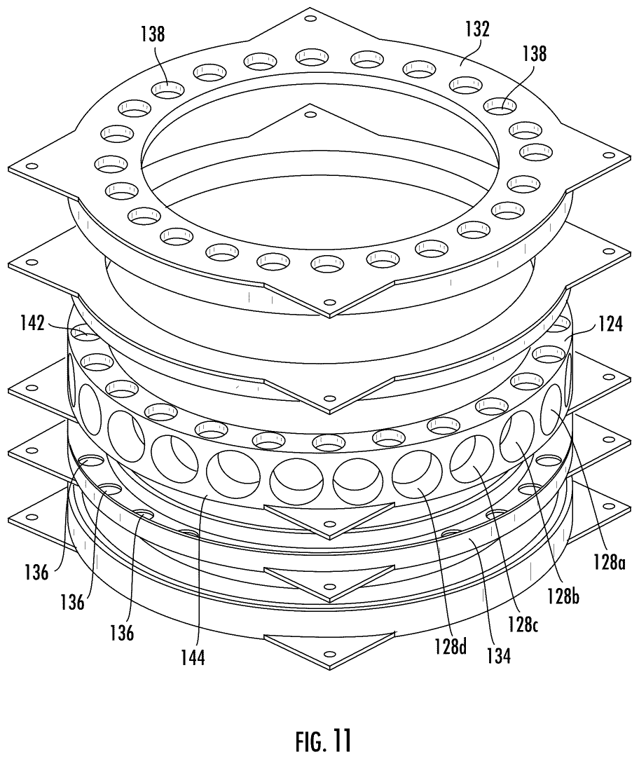

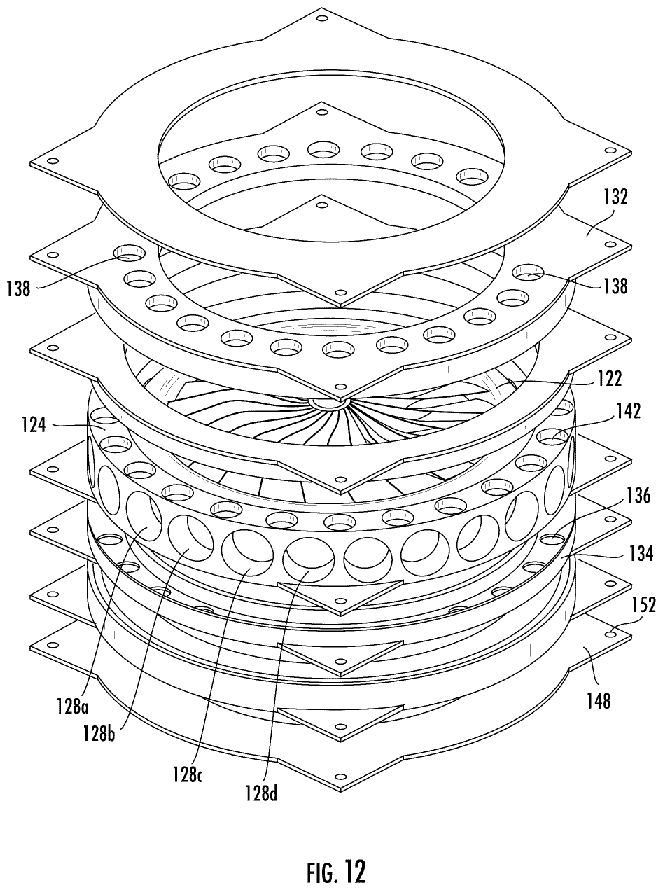

FIGS. 8-12 illustrate an alternative embodiment of an electric motor (120) featuring a rotor (122) that levitates within a surrounding stator (124). This embodiment is the same in all other respects to the embodiment described in connection with FIGS. 1-7. Namely, stator (124) includes a series of electromagnets (126) that interact with permanent magnets (128) within the periphery of the rotor (122) to create rotational movement. However, in this embodiment, the number of parts subject to wear or friction is greatly reduced by magnetically balancing the rotor (122) within the outer stator (124).

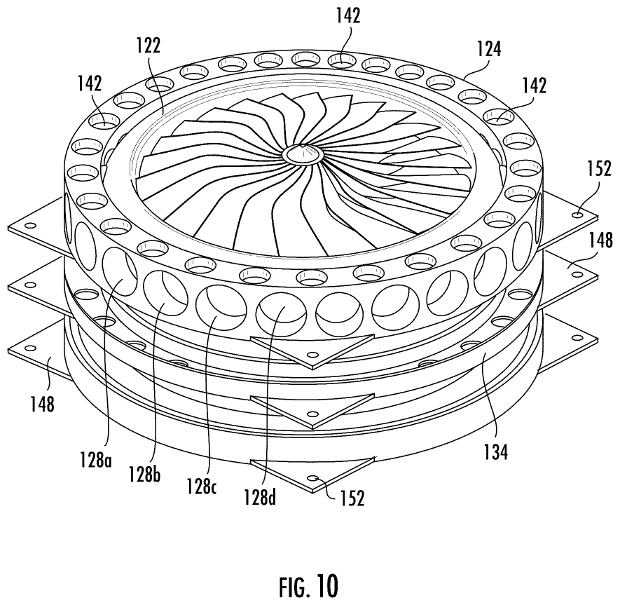

Turing now to FIG. 8, one of two opposing housings is depicted. This embodiment utilities an upper (132) and a lower housing (134). The depicted lower housing (134) includes an array of upwardly facing permanent magnets (136). Likewise, the upper housing (132) includes an array of downwardly facing permanent magnets (138). As illustrated in FIGS. 10-12, upper and lower housings (132, 134) come together to form a chamber for the associated stator (124). Stator (124) includes a peripheral array of upwardly and downwardly (142, 144) facing permanent magnets. The upwardly facing magnets (142) of stator (124) have the same polarity as the downwardly facing permanent magnets (138) of the upper housing (132). Likewise, the downwardly facing magnets (144) of stator (124) have the same polarity as the upwardly facing permanent magnets (136) of the lower housing (134). The strength of these magnets is selected to allow rotor (122) to be vertically suspended within the chamber created by the upper and lower housings (132, 134). This vertical suspension is achieved by the polarity and strength of the magnets within the upper housing (132), lower housing (134), and stator (124).

Rotor (122) is also horizontally suspended within stator (124). This vertical suspension is achieved via electromagnets (126) positioned within the periphery of stator (124) and corresponding permanent magnets (128) within periphery of the rotor (122). The peripheral electromagnets (126) of the stator are grouped in a repeating pattern of three. This includes a levitating electromagnet (128a), an electromagnet of a first phase (128b), an electromagnet of a second phase (128c), and an electromagnet of a third phase (128d). A hall effect sensor (146) is also included. The three phases of the electromagnets (128b, 128c, and 128d) interact with the permanent magnets (128) within the periphery of rotor (122) to impart rotational motion on rotor (122). The hall sensors (146) are included to detect the side-to-side distance between the rotor (122) and the surrounding stator (124). The levitating electromagnet (128a) can be electrically adjusted to change the magnetic attraction between the levitating electromagnet (128a) and the permanent magnets (128) of rotor (122). This, in turn, allows for small spacing adjustments to be made such that the rotor (122) and stator (124) do not come into contact, thereby ensuring that rotor (122) remains levitating within stator (124). FIGS. 10-12 also illustrate a number of additional mounting plates (148) with associated mounting points (152) that can be secured to the upper and lower housings (132, 134) to allow the assembled device (120) to be mounted to equipment (not shown) as needed.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A thrust producing electric motor (20) comprising:
a static central shaft (22);
a rotor (24) including a central bearing (26) and an outer peripheral extent (28), a series of permanent magnets (32) secured within the peripheral extent (28) of the rotor (24), with immediately adjacent permanent magnets (32) having an opposite polarity, the static central shaft (22) being positioned within the central bearing (26);
a series of angled blades (34), each angled blade (34) being attached to and extending outwardly from the central bearing (26) of the rotor (24), the series of angled blades (34) function to produce thrust upon rotation of the rotor (24) about the static central shaft (22);
a stator (36) positioned about the rotor (24) but not in physical contact with the rotor (24), the stator (36) having an inner peripheral extent (38), the inner peripheral extent (38) housing a series of electromagnets (42), with immediately adjacent electromagnets (42) being driven by a different phased current, whereby the electromagnets (42) of the stator (26) and the permanent magnets (32) of the rotor (24) interact to rotate the rotor (24) about the static central shaft (22);
an upper housing (44) with mounting points (46), the upper housing (44) including a series of spokes (48) and a central opening (52), the static central shaft (22) positioned within the central opening (52) of the upper housing (44);
a lower housing (54) with mounting points (56), the lower housing (54) including a series of spokes (58) and a central opening (62), the static central shaft (22) positioned within the central opening (62) of the lower housing (54), whereby the upper and lower housings (44, 54) function to enclose and protect the inner stator (36) and outer rotor (24).

2. An electric motor comprising:
a rotor including a central opening and an outer peripheral extent, a series of magnets secured within the peripheral extent of the rotor, with immediately adjacent magnets having an opposite polarity;
a stator positioned about the rotor, the stator having an inner peripheral extent, the inner peripheral extent housing a series of electromagnets, whereby the electromagnets of the stator and the magnets of the rotor interact to rotate the rotor; \
wherein the rotor and stator are not in physical contact and are separated by an airgap.

3. The electric motor as described in claim 2 further comprising an upper housing and a lower housing that are brought together to enclose and protect the inner stator and outer rotor.

4. The electric motor as described in claim 2 further comprising a series of angled blades, each angled blade being attached to and extending outwardly from the central bearing of the rotor, the series of angled blades function to produce thrust upon rotation of the rotor.

5. The electric motor as described in claim 2 wherein the magnets within the rotor are permanent magnets.

6. The electric motor as described in claim 2 wherein immediately adjacent electromagnets are driven by a different phased current.

7. The electric motor as described in claim 2 wherein the rotor is mounted upon and rotates about a static central shaft.

8. A levitating electric motor comprising:
upper and lower housings positioned to form a chamber, the upper housing having a series of downwardly facing permanent magnets, and the lower housing have a series of upwardly facing permanent magnets;
a stator positioned within the chamber, the stator having upwardly facing permanent magnets that interact with the downwardly facing permanent magnets of the upper housing, the stator also having downwardly facing permanent magnets that interact with the upwardly facing permanent magnets of the lower housing, the upwardly and downwardly facing permanent magnets functioning to vertically balance that stator within the chamber, the stator also including an inner peripheral extent, the inner peripheral extent housing a series of electromagnets and a hall effect sensor, the series of electromagnets and the hall effect sensor being coupled to a current source;
a rotor positioned within the chamber, a series of permanent magnets secured within a peripheral extent of the rotor, with immediately adjacent permanent magnets having an opposite polarity;
whereby the electromagnets of the stator interact with the permanent magnets of the rotor to impart rotational motion to the rotor, and wherein the hall effect sensor measures the distance between the stator and the rotor with the measured distance being adjustable by altering the current to the electromagnets.

9. The motor as described in claim 8 further comprising a series of angled blades position within an interior of the rotor.

10. The motor as described in claim 8 further comprising a static shaft that is used to support the rotor.
